(19) United States
(12) Patent Application Publication
(10) Pub. No.: US 2009/0182520 A1
(43) Pub. Date: Jul. 16, 2009

(54) ASSESSMENT OF DIAMOND COLOR

(76) Inventors: Yoav Luxembourg, Herzlia (IL); Erez Avrahamov, Tel-Aviv (IL); Refael Barkan, Nes Ziona (IL); Yehuda Shekel, Jerusalem (IL); Ira Hartman, Hashmonaim (IL)

Correspondence Address: NIXON & VANDERHYE, PC, 901 NORTH GLEBE ROAD, 11TH FLOOR, ARLINGTON, VA, 22203, US

(21) Appl. No.: 12/097,015

(22) PCT Filed: Dec. 12, 2006
(86) PCT No.: PCT/IL06/01424

§ 371 Date: Nov. 13, 2008

Related U.S. Application Data
(60) Provisional application No. 60/749,085, filed on Dec. 12, 2005.

(51) Int. Cl. G06F 19/00; G01N 21/87

(52) U.S. Cl. 702/81; 356/30

(57) ABSTRACT

Disclosed are methods and devices for assessing the colors of diamonds. In embodiments, the color of finished diamonds cut from a given rough diamond is assessed by analyzing the effect on light interacting with the rough diamond to give a reasonable (that is to say commercially significant) assessment of the color quality of the finished diamond.

### FIELD AND BACKGROUND OF THE INVENTION

The present invention relates to the field of gemology and specifically, to methods and devices for the assessment of the color of a diamond. In embodiments, the color and other qualities of finished diamonds cut from a given rough diamond are assessed by analysis of the rough diamond.

Diamond is the hardest natural substance in the world. The hardness of diamonds, 10 on the Mohs scale, makes diamond a valuable industrial product. However, it is its adamantine luster, brilliance, fire, and scintillation that gives the diamond its value in the hearts of men.

Natural diamonds were produced some 200 kilometers beneath the earth's surface and transported upwards through the crust via kimberlite or lamproite pipes. Diamonds are primarily won by mining alluvial deposits, glacial tills or the terminii of kimberlite or lamproite pipes. The mined ore is crushed to release the diamonds from the surrounding material. The rough diamonds are then separated from the crushed ore and other material (gangue), usually in a three step process. In a first step, the dense rough diamonds are separated from the less dense gangue, generally using a washing pan, separation cone, cyclone or the like. In a second step, the rough diamonds are further separated from gangue with the use of an X-ray fluorescence separator or a grease table. In a third step, a diamond-sorting professional isolates gemstone-quality rough diamonds from industrial grade and waste diamonds. The thus isolated gemstone-quality rough diamonds resemble innocuous pebbles that are far from noteworthy to the untrained eye.

The rough diamonds are sorted, sold and eventually brought to a diamond processing workshop. At the workshop, the number and shapes of finished diamonds to be cut from a given rough diamond are determined. The rough diamond is first sawed and/or cleaved along naturally occurring veins to give a rough shape to the incipient finished diamonds. The exterior angles of the incipient finished diamond are blunted against another diamond. Finally, the incipient finished diamonds are polished to form the facets that define the final shape of the finished diamonds.

The beauty and value of a finished diamond are determined by the four-Cs: cut, carat weight, clarity and color.

The cut of a finished diamond refers to how well the proportions of the diamond approach the ideal geometry of the shape in which the finished diamond is cut and is rated on a scale of ideal, premium, very good, good, fair and poor. The cut is determined primarily by the skill of the diamond cutter, although often a skilled diamond cutter will choose to produce a larger but less well-cut finished diamond. All other factors being equal, the better cut, that is the closer to ideal geometry, the more valuable the finished diamond. The cut is the only one of the four Cs which is determined largely by man.

The weight of a diamond is expressed in units of carats (0.2 gram) or points (0.01 carat). All other factors being equal, the larger the finished diamond, the greater the value.

The clarity of the finished diamond refers to the extent of two categories of diamond imperfections. Internal imperfections are minute inclusions whereas external imperfections are surface irregularities referred to as blemishes. The fewer the imperfections, the greater the clarity and the more valuable the finished diamond.

The colors of diamonds include colorless, pale yellow, brown, amber, blue, green, orange, red and black. The color is apparently the result of trace elements and compounds such as nitrogen, boron and compounds thereof trapped within the crystal matrix of the diamonds in amounts of parts per million. Generally, the less color the greater the value of the stone. Yellow, brown or gray diamonds are graded on a scale from D down through Z, where the absolute finest colorless stones carry a D rating. Specifically, colors D, E and F are essentially without color and differ in transparency. Colors G, H, I and sometimes J usually show little or no color in the face-up position (as set in jewelry) for most diamond shapes. However, emerald cut diamonds more easily show color from G and inferior colors whiles round brilliant diamonds of ideal cut quality may show slightly less color than the grade given. As the color becomes more intense, the grade for color descends the scale and the value of the diamond plummets. Roughly, for an internally flawless round brilliant finished diamond of 1 carat, prices fall about 25% in going from D to E color, and then about 10% more for each additional grade (F=−35%, G=−45, H=−55%) until one gets to H color, where the difference decreases to about 5% less going from H to I color (I=−60%).

Diamonds having “fancy” colors such shades of amber, blue, green, orange, red and black are evaluated by a different set of color standards. These standards take into consideration various factors such as hue and saturation. Fancy colored diamonds are very expensive because of their extreme rarity.

Many diamonds fluoresce under ultraviolet light. The fluorescence of a diamond is defined by its intensity as None, Slight, Faint, Medium, Strong, or Very Strong. Generally the most common fluorescent color, blue, does not influence the value of a diamond unless the intensity is Strong or Very Strong. Strong blue fluorescence reduces the value of diamonds having the high colors D, E, and F but increases the value of diamonds of colors J and lower. Other colors of fluorescence such as yellow, green or orange reduce the value of a diamond.

In the art, methods and devices for evaluating the color of finished diamonds have been described, see for example, U.S. Pat. Nos. 3,867,032; 4,012,141; 4,291,975; 4,394,580; 4,482,245; 4,508,449; 4,875,771; 5,835,200; 5,883,388; 6,020,954; 6,473,164 and 6,515,738.

In the art, it is accepted to rate a finished diamond using a standard finished diamond color rating device produced by Zvi Yehuda (Ramat Gan, Israel). The Zvi Yehuda device gives a finished diamond a “Zvi Yehuda quality rating”, a single number that is correlated with the D through Z color grade.

It is of great economic importance to be able to assess the real value of a given rough diamond, which is determined by the sum of the values of the finished diamonds cut therefrom. From the size and shape of a given rough diamond the number, shapes and sizes of finished diamonds that can be cut therefrom estimated. However, neither the color nor the clarity of the finished diamonds can be determined from the rough diamond.

The clarity of a finished diamond is to some extent determined by the diamond cutter who chooses the sizes and shapes of the finished diamonds to increase the clarity of the finished diamonds. That said, due to the minute size of the imperfections which define clarity, it is not possible to determine the clarity of finished diamonds from study of a given rough diamond.

As noted above, the color and the quality of the color are of great significance in determining the value of a finished diamond and it is of great value to know the color of a rough diamond prior to processing. If the color is known, valuation is rational for both insurance and for commercial purposes, reducing the financial uncertainty to a diamond trader. If the color of a rough diamond is known, a diamond trader can purchase a desired color of diamond. If the color of a rough diamond is known, more skilled diamond cutters can be assigned to cut more valuable rough stones.

It is known to “enhance” the color of certain inferior diamonds using the HTHP process. Such stones are subject to high temperatures and high pressures that lighten or remove the natural color of the stone, increasing its value. As many consumers are interested in knowing whether a finished diamond is natural or has been “enhanced”, it is important to be able to identify “enhanced” diamonds. Legitimate diamond enhancers such as Bēllataire Diamonds Inc. (New York, N.Y., USA) produce and then inscribe “enhanced” diamonds as such, but it is known that unscrupulous persons remove the inscription. Further, it cannot be discounted that less-reputable persons will attempt to pass-off “enhanced” diamonds as natural diamonds. Unfortunately, to distinguish a natural diamond from an “enhanced” diamond requires the use of extremely sophisticated instruments such as FTIR and Raman spectroscopy, that are not readily available and are not completely reliable.

Synthetic diamonds produced by chemical vapor deposition (CVD) of carbon are commercially available for example from Apollo Diamond Inc. (Boston, Mass., USA). Synthetic diamonds produced from graphite by the HPHT (high pressure high temperature) process are commercially available for example from Adia Diamonds (Battle Creek, Mich., USA), Gemesis Corporation (Sarasota, Fla., USA), Joint Venture Tairus (Novosibirsk, Russia) and Lifegem (Elk Grove Village, Ill., USA). Synthetic diamonds are substantially chemically and structurally identical to natural diamonds. To avoid the possibility that mined diamonds will be passed off as synthetic diamonds, or that synthetic diamonds will be passed off as mined diamonds, reputable manufacturers of synthetic diamonds often use a laser to enscribe the diamonds with a serial number or other identifier. However, just as with enhanced diamonds, less-reputable persons may attempt to pass-off synthetic diamonds as natural diamonds. Just as with enhanced diamonds, to distinguish a natural diamond from a synthetic diamond requires the use of extremely sophisticated instruments such as FTIR and Raman spectroscopy, that are not readily available and are not completely reliable.

In U.S. Pat. No. 4,907,875 is disclosed a method described as being useful for determining the color but not the quality of the color of rough diamonds. A rough diamond is irradiated with two or more monochromatic coherent beams of light of a wavelength capable of causing Raman radiation, simultaneously or sequentially, and the resulting Raman radiation measured. The diamond is rotated and irradiated from a plurality of orientations, and the mean of the intensity of Raman radiation emitted from all orientations for each of the wavelengths is measured. It was found that all diamonds of a given color, regardless of quality, gave similar ratios of intensity. For yellow diamonds, the ratio of Raman radiation produced by radiation at 514.5 nm to 488 nm (I_{514.5}/I₄₈₈) was about 8 while I_{514.5}/I_{647.1} was about 7. For green diamonds, the ratio I_{514.5}/I₄₈₈ and I_{514.5}/I_{647.1} were both about 4. The method of U.S. Pat. No. 4,907,875 has a number of disadvantages. One disadvantage is that a given ratio is only valid for a specific size of diamond so reference values are required for all colors as well as for sizes. Further, the method determines a color of a diamond, but not the quality of the color.

Thus, in the art there is no way to accurately assess the color of a rough diamond. Rather, a diamond merchant bases decisions on what is, at best, an educated guess as to the quality of the color of the stone. This is a far from ideal situation when one considers that it is not unusual for a large rough diamond to have a value in excess of $500,000.

It would be highly advantageous to have an improved method for assessing the color of finished diamonds cut from a given rough diamond.

### SUMMARY OF THE INVENTION

Embodiments of the present invention successfully address at least some of the shortcomings of the prior art by providing a method and a device for assessing the color and other qualities of diamonds. The teachings of the present invention are based on the use of a correlation between the light-effecting properties of a diamond and the color or other quality of the diamond. In embodiments, the teachings of the present invention provide for the assessment of color and other qualities of finished diamonds to be cut from a rough diamond by examination of the rough diamond. In embodiments, values of the second derivative of a VIS-NIR spectrum of a diamond are used to assess the color grade of a diamond.

In an aspect of the present invention, a relationship between spectroscopic data and the color quality of a diamond is determined, for example, an equation of the color grade of a diamond as a function of spectral values, e.g., the second derivative of an absorption spectrum at a limited number of wavelengths.

Thus, according to the teachings of the present invention is provided a method for determining a relationship between spectroscopic data and the color quality of a diamond, comprising: a) providing a group of diamonds; b) acquiring spectra of the diamonds, at least one spectrum for each diamond of the group of diamonds; c) determining the color quality of each diamond of the group of diamonds (e.g., using methods known in the art); and d) determining a relationship between a variability between the spectra and a variability of the color quality. In preferred embodiments, the color quality is related to color grades and qualities known in the art (see Table 2).

In embodiments, the group of diamonds comprises or even consists of rough diamonds. In embodiments, the group of diamonds comprises processed diamonds (diamonds that have undergone at least some of the process of producing finished diamonds from rough diamonds). In embodiments, the group of diamonds comprises finished diamonds. In a preferred embodiment, the spectra are acquired when the diamonds are rough, but the color quality is determined when the same diamonds have been processed or are finished. It has been found that the teachings of the present invention allows assessment of the color quality of a finished diamond by analysis of the rough diamond from which the diamond is cut.

In embodiments, the group of diamonds comprises diamonds having a fluorescence of no less than faint (Faint, Medium, Strong, or Very Strong). In embodiments, the group of diamonds comprises diamonds having a fluorescence of no greater than slight (None or Slight). In embodiments, the group of diamonds comprises colorless diamonds. In embodiments, the group of diamonds comprises fancy yellow diamonds.

In embodiments, the spectra are absorption spectra.

In embodiments, the spectra are acquired from light reflected from a diamond, transmitted through a diamond, transreflected through a diamond, scattered by a diamond and/or refracted from a diamond.

In embodiments, the spectra comprise visible wavelengths of light. In embodiments, the spectra comprise near-infrared wavelengths of light.

In embodiments, each of the spectra are acquired through a plurality (in embodiments, at least 3, at least 5 and even at least 9) of light paths through different sides of a diamond from the group of diamonds. For example, in embodiments, for each diamond of the group a number of individual spectra are measured, each individual spectrum from a different direction. The individual spectra are summed or averaged to yield the acquired spectrum.

In embodiments, the variability between the spectra comprises variability apparent in mathematically processed spectra, and the method further comprises: e) mathematically processing the acquired spectra to yield the mathematically processed spectra. By mathematical processing is meant one or more mathematical manipulations, including but not limited to one or more mathematical manipulation selected from the group consisting of smoothing, baseline correction, subtracting, multiplying, dividing, multiplicative scatter correction (MSC), detrending, derivatization, first order derivatization, second order derivatization, third order derivatization, fourth order derivatization, smoothing and Savitzky-Golay smoothing. In preferred embodiments, the spectra are mathematically processed by second order derivatization.

In embodiments, determining the relationship between variability in the spectra (e.g., the processed spectra, e.g., the second derivatives of the spectra) and variability of the color quality includes using multivariate analysis. Suitable multivariate analysis techniques include but are not limited to binomial regression, multiple linear regression (MLR), multiple regression analysis, non-linear regression, partial least squares (PLS) regression, principal component analysis (PCA), principal component regression (PCR) and artificial neural networks. In embodiments, the multivariate analysis comprises multiple linear regression (MLR). In embodiments, the multivariate analysis comprises partial least squares (PLS).

In embodiments, the relationship determined is a linear relationship of color quality to at least one value from a spectrum (e.g., a processed spectrum) of a member of the group of diamonds. For example, in embodiments, the relationship determined is a linear relationship of color quality (e.g., D-Z color grade, see Table 2) as a function of values from the second derivative of an absorption spectrum at a limited number (2, 3, or even more) of wavelengths.

In an aspect of the present invention, the quality of the color (for example according to the D-Z color grade scale) of a diamond (e.g., a diamond with an unknown color quality) is assessed, when the diamond is rough, finished or being processed. In embodiments the quality of the color of finished diamonds cut from a rough diamond are assessed by examination of the rough diamond.

Thus, according to the teachings of the present invention there is provided a method of assessing the color grade of a diamond, comprising: a) acquiring a spectrum of a diamond; b) using a mathematical manipulation method to mathematically process the acquired spectrum to provide a processed spectrum of the diamond; c) acquiring values from the processed spectrum at least two different wavelengths; e) using a relationship of values from the processed spectrum of the diamond at the at least two wavelengths to a value related to the color quality of a diamond to assess the color quality of said diamond. For example, in embodiments, the relationship if an equation where the color quality (e.g., see Table 2) is a function of one or more values from the processed spectrum, e.g., the values of the second derivative of an absorption spectrum at one or more wavelengths. In embodiments, the result is reported, e.g., as a number, as a color, as graphic representation, or the like.

In embodiments, the diamond is a rough diamond. In embodiments, the diamond is a finished diamond. In embodiments, the diamond is a processed diamond. In embodiments, the diamond is a rough diamond and the color quality assessed is the color quality of a finished diamond cut from the rough diamond.

In embodiments, the diamond has a fluorescence of no less than faint (that is to say, Faint, Medium, Strong, or Very Strong), e.g., a fluorescent colorless diamond or a fluorescent fancy yellow diamond. In embodiments, the diamond is a colorless diamond, e.g., having no or slight fluorescence. In embodiments, the diamond is a fancy yellow diamond, e.g., having no or slight fluorescence.

In embodiments, the acquired spectrum is an absorption spectra. In embodiments, the acquired spectrum is from light reflected from the diamond, transmitted through the diamond, transreflected through the diamond, scattered by the diamond and/or refracted through the diamond.

In embodiments, the acquired spectrum comprises visible wavelengths of light. In embodiments, the acquired spectrum comprises near-infrared wavelengths of light.

In embodiments, the spectrum is acquired through a plurality (in embodiments, at least 3, at least 5 and even at least 9) of light paths through different sides of the diamond. For example, in embodiments, a number of individual spectra are measured, each individual spectrum from a different direction. The individual spectra are summed or averaged to yield the acquired spectrum.

In embodiments, the mathematically manipulation is at least one mathematical manipulation selected from the group consisting of smoothing, baseline correction, subtracting, multiplying, dividing, multiplicative scatter correction (MSC), detrending, derivatization, first order derivatization, second order derivatization, third order derivatization, fourth order derivatization, smoothing and Savitzky-Golay smoothing. In embodiments, the mathematical manipulation comprises second order derivatization of the acquired spectrum to provide the processed spectrum.

In embodiments, at least one value is of a wavelength is between about 850 nm and about 2110 nm. In embodiments, at least one value is of a wavelength between about 455 nm and about 850 nm. In embodiments, the values are acquired from the processed spectrum at least three different wavelengths. In embodiments, the at least three wavelengths include a wavelength between about 450 and 460 nm, a wavelength between about 735 and 745 nm and a wavelength between about 1305 and 1315 nm, especially for diamonds having a fluorescence of no less than faint or colorless diamonds. In embodiments, the at least three wavelengths include a wavelength between about 1305 and 1315 nm, a wavelength between about 2105 and 2115 nm and a wavelength between about 2280 and 2290 nm, especially for fancy yellow diamonds.

In embodiments, the relationship is a linear relationship of color quality to the values acquired from the processed spectrum.

As noted above, embodiments of the present invention are based on using a relationship of values taken from a spectrum of a diamond to the color quality of the diamond to assess the quality of color of the diamond. It has been found that in some instances, the accuracy of assessment of the color quality of a diamond may be improved by providing such a relationship for a group of diamonds having a given characteristic. For example, it has been found that assessment of the color quality of non-fluorescent colorless diamonds is more accurate when using a linear relationship between the values of the second derivative of an absorption spectrum at three wavelengths and the color quality while the assessment of the color quality of non-fluorescent fancy yellow diamonds is more accurate when using a different relationship of values of the second derivative of an absorption spectrum at three different wavelengths. Thus, an aspect of the present invention includes classifying diamonds into groups to allow the use of a preferred relationship between spectral values and color quality. In embodiments, a diamond (rough, processed or finished) is classified as being a member of a group, for example, the group of non fluorescent colorless diamonds or the group of non fluorescent fancy yellow diamonds. In embodiments, it is determined if a diamond (rough, processed or finished) is enhanced (HTHP enhanced)/synthetic.

Thus, according to the teachings of the present invention there is provided a method of classifying a diamond, comprising: a) irradiating a diamond with a plurality of wavelengths of light from an illumination unit; b) acquiring a spectrum of the light subsequent to interaction with the diamond using a detection unit; c) mathematically processing the acquired spectrum using a spectrum processing method to provide a processed spectrum; and d) comparing the processed spectrum to at least one reference spectrum of a group of diamonds so as to determine if the diamond is a member of the group of diamonds thereby classifying the diamond as belonging to the group or as not belonging to the group. Any comparison method known in the art is suitable for comparing the processed spectrum to the at least one reference spectrum.

In embodiments, the diamond is a rough diamond. In embodiments, the diamond is a finished diamond. In embodiments, the diamond is a processed diamond.

In embodiments, the group comprises (or essentially consists of or consists of) enhanced diamonds (HTHP) and/or synthetic diamonds (HPHT or CVD). In embodiments, the group comprises (or essentially consists of or consists of) HTHP enhanced diamonds. In embodiments, the group comprises (or essentially consists of or consists of) non-fluorescent colorless diamonds. In embodiments, the group comprises (or essentially consists of or consists of) non-fluorescent fancy yellow diamonds. In embodiments, the diamond has a fluorescence of no more than slight (none or slight).

In embodiments, the result is reported, e.g., as a number, as a color, as graphic representation, and the like.

In an embodiment, the plurality of wavelengths comprises wavelengths selected from the group consisting of ultraviolet (about 190 to about 400 nm), visible (about 400 to about 700 nm), infrared (about 700 to about 3×10⁶ nm) and preferably near-infrared (about 700 to about 2500 nm).

In embodiments, the plurality of wavelengths comprises a continuous spectrum.

In embodiments, the plurality of wavelengths comprises a spectrum of discrete wavelengths having wavelength increments of not more than 50 nm, not more than 30 nm, not more than 20 nm and even not more than 10 nm.

In embodiments, the light is incoherent. In embodiments, the light is collimated.

In embodiments, irradiation is with a limited range of wavelengths of light at any one time.

In embodiments, the illumination unit comprises an adjustable monochromator.

In embodiments, the acquisition is of substantially the entire plurality of wavelengths of light at any one time.

In embodiments, the acquisition is of a limited range of wavelengths of light at any one time.

In embodiments, the detection unit comprises an adjustable monochromator.

In embodiments, the irradiation is with substantially the entire plurality of wavelengths of light at any one time.

In embodiments, the interaction of the light with the diamond is through a plurality (in embodiments, at least 3, at least 5 and even at least 9) of light paths through different sides of the diamond. In embodiments, the irradiation is through one side of the diamond at any one time. In embodiments, the acquisition is from a single direction relative to the diamond at any one time. In embodiments, the acquisition is simultaneously from a plurality (in embodiments, at least 3, at least 5 and even at least 9) of directions relative to the diamond at any one time. In embodiments, the irradiation is simultaneously through a plurality (in embodiments, at least 3, at least 5 and even at least 9) of sides of the diamond. In embodiments, the acquisition is from a single direction relative to the diamond at any one time. In embodiments, the acquisition is simultaneously from a plurality (in embodiments, at least 3, at least 5 and even at least 9) of directions relative to the diamond.

In embodiments the spectrum acquired comprises light reflected (specularly and/or diffusively), comprises light transmitted through, comprises light transreflected through, comprises light scattered by and/or comprises light refracted by the diamond.

In embodiments, the spectrum processing method includes mathematical manipulation of the acquired spectrum. Suitable mathematical manipulations include but are not limited to smoothing, baseline correction, subtracting, multiplying, dividing, multiplicative scatter correction (MSC), detrending, derivatization, first order derivatization, second order derivatization, third order derivatization, fourth order derivatization, smoothing and Savitzky-Golay smoothing. In preferred embodiments, the mathematical manipulation comprises second order derivatization of the acquired spectrum to provide the processed spectrum.

In embodiments, the at least one reference spectrum comprises a spectrum of a diamond that is a known member of the group (generally an acquired spectrum that has also been mathematically processed using the same spectrum processing method).

In embodiments, the at least one reference spectrum comprises a library of spectra, each of a diamond that is a known member of the group (generally acquired spectra that have also been mathematically processed using the same spectrum processing method).

In embodiments, the at least one reference spectrum comprises an average of a plurality of spectra of diamonds that are known members of the group (generally of acquired spectra that have also been mathematically processed using the same spectrum processing method, the average performed before or after the mathematical processing).

In embodiments, the comparing provides a correlation value indicative of the degree of similarity of the processed spectrum to the at least one reference spectrum and the determining if the diamond is a member of the group of diamonds includes the correlation value exceeding a predetermined threshold.

According to the teachings of the present invention there is also provided a device for assessing the color of diamonds comprising: a) a gemstone holder; b) an illumination unit, to irradiate a gemstone held in the holder with light; and c) a detection unit, to measure a spectrum of light produced by light from the illumination unit subsequent to interaction of the light with a gemstone; wherein each wavelength range in an abscissa of the spectrum of light includes intensities of light following a plurality of substantially different light paths relative to a gemstone.

In embodiments, the gemstone holder is reflective, whether diffusively or specularly reflective. In embodiments, the gemstone holder is substantially non-reflective. In embodiments, the gemstone holder is configured to rotate about an axis.

In embodiments, the illumination unit is configured to irradiate a gemstone with light comprising wavelengths selected from the group consisting of ultraviolet (from about 190 to about 400 nm), visible (from about 400 to about 700 nm), infrared (from about 700 to about 3×10⁶ nm) and near-infrared (from about 700 to about 2500 nm). In embodiments, the illumination unit is configured to irradiate a gemstone with light comprising wavelengths from about 400 nm to about 2500 nm.

Generally, an illumination unit comprises at least one light source. In embodiments, the illumination unit comprises an incoherent light source. In embodiments, the illumination unit comprises a light source producing a continuous spectrum of light. Suitable light sources include but are not limited to tungsten-halogen lamps, Xenon lamps, ultraviolet lamps, deuterium lamps, high pressure mercury lamps, medium pressure mercury lamps, light-emitting diodes, Nichrome light sources and globars.

In embodiments, the illumination unit is configured to focus light at a gemstone held in the gemstone holder, for example by including a focusing element such as a lens. In embodiments, the illumination unit is configured to project a beam of light at a gemstone held in the gemstone holder, for example by including a beam-producing unit such as a beam shaper. In embodiments, the illumination unit is configured so that the light at the first point of interaction with a gemstone held in a gemstone holder covers a substantially large proportion of the gemstone, for example greater than 50%, greater than 80% and even the gemstone in its entirety. In embodiments, the illumination unit is configured so that the light at the first point of interaction with a gemstone held in a gemstone holder covers a substantially small proportion of the gemstone, for example no more than 50%, no more than 30%, no more than 15%, no more than 5% and even no more than 1%,

In embodiments, the illumination unit comprises a collimator.

In embodiments, the illumination unit comprises an adjustable monochromator. Suitable adjustable monochromators include optical filters, discrete optical filters, wedge optical filters, tilting filter wheels, interference filters, prisms, diffraction gratings, holographic diffraction gratings, moving diffraction gratings, stigmatic diffraction gratings, Fourier-transform interferometers, Michelson Fourier-transform interferometers, Wishbone Fourier-transform interferometers, Fishbone Fourier-transform interferometers, Crystal Fourier-transform interferometers, Acoustic Optical Tunable Filters and Optical Micro Electronic Mechanical Systems.

In embodiments, the detection unit comprises a collimator.

In embodiments, the detection unit comprises an adjustable monochromator. Suitable adjustable monochromators include optical filters, discrete optical filters, wedge optical filters, tilting filter wheels, interference filters, prisms, diffraction gratings, holographic diffraction gratings, moving diffraction gratings, stigmatic diffraction gratings, Fourier-transform interferometers, Michelson Fourier-transform interferometers, Wishbone Fourier-transform interferometers, Fishbone Fourier-transform interferometers Crystal Fourier-transform interferometers, Acoustic Optical Tunable Filters and Optical Micro Electronic Mechanical Systems.

In embodiments, the detection unit is configured to detect light reflected by a gemstone held in the gemstone holder, specularly and/or diffusively and/or light transreflected through a gemstone held in the gemstone holder and/or light transmitted through a gemstone held in the gemstone holder and/or light refracted by a gemstone held in the gemstone holder and/or light scattered from a gemstone held in the gemstone holder.

In embodiments, the illumination unit configured to irradiate a gemstone from a plurality of directions. In embodiments, the irradiation is simultaneously from the plurality of directions. In embodiments, the irradiation is from a substantially single direction at any one time. In embodiments, the illumination unit comprises a light source configured to rotate about the gemstone holder. In embodiments, the illumination unit comprises a plurality of light sources arrayed about the gemstone holder.

Generally, a detection unit includes a light sensitive component. Suitable light sensitive components include but are not limited to optical spheres, photomultiplier tubes, photomultiplier components, pyroelectric components, thermocouples, thermistors and photon detectors. In embodiments, a detection unit includes a crystal such as Si, BaS, PbS, PbSe, InAs, InSb, Si/PbS or InGaAs.

In embodiments, the detection unit configured to measure the spectrum of light from a plurality of directions. In embodiments, the measurement is simultaneously from the plurality of directions. In embodiments, the measurement is from a substantially single direction at any one time. In embodiments, the detection unit comprises a light sensitive component configured to rotate about the gemstone holder.

In embodiments, a device of the present invention further comprises a fluorescence detector to detect fluorescence from a gemstone held in the gemstone holder.

In embodiments, the device comprises a spectrum-processing unit configured to process an acquired spectrum of a diamond and return a processed spectrum. In embodiments, the processing includes a mathematical manipulation. Suitable mathematical manipulations include but are not limited to smoothing, baseline correction, subtracting, multiplying, dividing, multiplicative scatter correction (MSC), detrending, derivatization, first order derivatization, second order derivatization, third order derivatization, fourth order derivatization, smoothing and Savitzky-Golay smoothing. In preferred embodiments, the mathematical manipulation comprises second order derivatization of an acquired spectrum to provide a processed spectrum.

In embodiments, the device comprises a spectrum-comparing unit configured to compare a processed spectrum to at least one reference spectrum (generally an acquired spectrum that has also been mathematically processed using the same spectrum processing method). In embodiments, the at least one reference spectrum is stored in the device. In embodiments, the at least one reference spectrum comprises a spectrum of a single diamond. In embodiments, the at least one reference spectrum comprises a library of spectra, each of a diamond. In embodiments, the at least one reference spectrum comprises an average of a plurality of spectra of diamonds.

In embodiments, the comparing provides a correlation value indicative of the degree of similarity of a processed spectrum to the at least one reference spectrum.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.
The term “method” refers to manners, means, techniques and procedures for accomplishing a given task including, but not limited to, those manners, means, techniques and procedures either known to, or readily developed from known manners, means, techniques and procedures by practitioners of the chemical, engineering, gemological and mathematical arts.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A and 1B depict embodiments of devices of the present invention where a rough diamond is irradiated from substantially a single direction and intensity of light interacting therewith is measured from a plurality of directions;

FIGS. 2A and 2B depict embodiments of devices of the present invention where a rough diamond is irradiated from substantially a single direction and intensity of light interacting therewith is measured from substantially a single direction;

FIGS. 3A and 3B depict embodiments of devices of the present invention where a rough diamond is irradiated from a plurality of directions and intensity of light interacting therewith is measured from a single direction;

FIG. 4 depicts acquired absorption (transreflection) spectra from 400 to 2500 nm of 100 rough diamonds showing the lack of distinguishing features in the spectra;

FIG. 5 depicts the second derivatives of absorbance (transreflectance) spectra of three different groups of diamonds: (A) non-fluorescent colorless rough diamonds; (B) non-fluorescent fancy-yellow rough diamonds; and (C) HTHP enhanced diamonds between 444 and 1068 nm; and

FIG. 6 depicts the second derivatives of absorbance (transreflectance) spectra of three different groups of diamonds: (A) non-fluorescent colorless rough diamonds; (B) non-fluorescent fancy-yellow rough diamonds; and (C) HTHP enhanced diamonds between 1112 and 2484 nm.

### EMBODIMENTS OF THE INVENTION

The present invention is of methods and devices for assessing the color and other qualities of diamonds, whether rough, processed or finished. In embodiments, the present invention is of methods and devices for assessing the quality of color (e.g., color grade) and other qualities of finished diamonds cut from a given rough diamond by examination of the rough diamond.

The principles and uses of the teachings of the present invention may be better understood with reference to the accompanying description, figures and example. In the figures, like reference numerals refer to like parts throughout. Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In the art, it is known that in some cases certain physical properties of a complex product (for example, a product comprising a multi-component variable mixture) can be predicted with reasonable accuracy by the study of spectral properties of the product that are seemingly unrelated to the physical properties. The methods are usually based on first studying the spectral properties of a large calibration set of products and the property of interest which is to be predicted. The data corresponding to the spectral properties of the materials is mathematically manipulated and processed to observe some correlation with the property of interest. Discovery of such a correlation is no trivial matter as a priori it is not possible to predict which spectral properties, if any, are correlated with the property of interest and which mathematical manipulations may reveal such a correlation. For example, in U.S. Pat. No. 5,641,962 non-linear multivariate analysis of infrared spectra of gasoline is used to predict the octane of the gasoline while in U.S. patent application Ser. No. 10/807,537 published as US 2005/0028932 regression analysis of an infrared spectrum of a chemical bath is used to predict etch rates of silicon in the bath. In such cases it is not clear why there is a correlation between the spectral properties of the material and the predicted properties.

Further, color is not an accurately defined absolute property that can be directly deduced from a given set of physical properties, but is rather a complex psychophysical concept. The perception of color is dependent on the interrelationship of the observer, the object and the light source and is strongly influenced by external factors such as object size, shape and surface characteristics, surrounding color and brightness and light source intensity, spectral characteristics and direction.

Herein is disclosed a method whereby the color quality and other qualities of diamonds are assessed with reasonable (that is to say, commercially significant) accuracy.

Aspects of the method of the present invention may be applied separately or together, as a continuous process or as separate steps. In embodiments only one or a few aspects of the method of the present invention are combined, while some aspects of the method are not performed. In embodiments, one or more aspects of the method of the present invention are performed on the same device. In embodiments, one or more aspects of the method of the present invention are performed on different devices.

### Assessment of the Quality of Color of a Diamond

In embodiments, a method of the present invention can be considered as including two main aspects: classification of a diamond to a certain group followed by assessing the quality of color of the diamond according to spectral characteristics of the diamond with reference to the group in which the diamond is classified.

### Preparation of Reference Spectra of a Group of Diamonds

Preferably, in order to classify a diamond as being a member of a group, a spectrum of a diamond or a spectrum of each of a plurality of diamonds of a given group is acquired as a reference spectrum or spectra.

The spectra acquired may be of any suitable wavelength and range of wavelengths, including ultraviolet (about 190 to about 400 nm), visible (about 400 to about 700 nm), infrared (about 700 to about 3×10⁶ nm) and near-infrared (about 700 to about 2500 nm). That said, in preferred embodiments the acquired spectra are in the visible and/or near-infrared wavelengths.

Although in embodiments it is possible to acquire a spectrum from light interacting with a given diamond through a single light path, it is preferred that the acquired spectrum be an average of spectra including light interacting with the diamond through a plurality of light paths.

Once acquired, the spectrum or spectra are mathematically manipulated to yield processed reference spectra that are characteristic of that group.

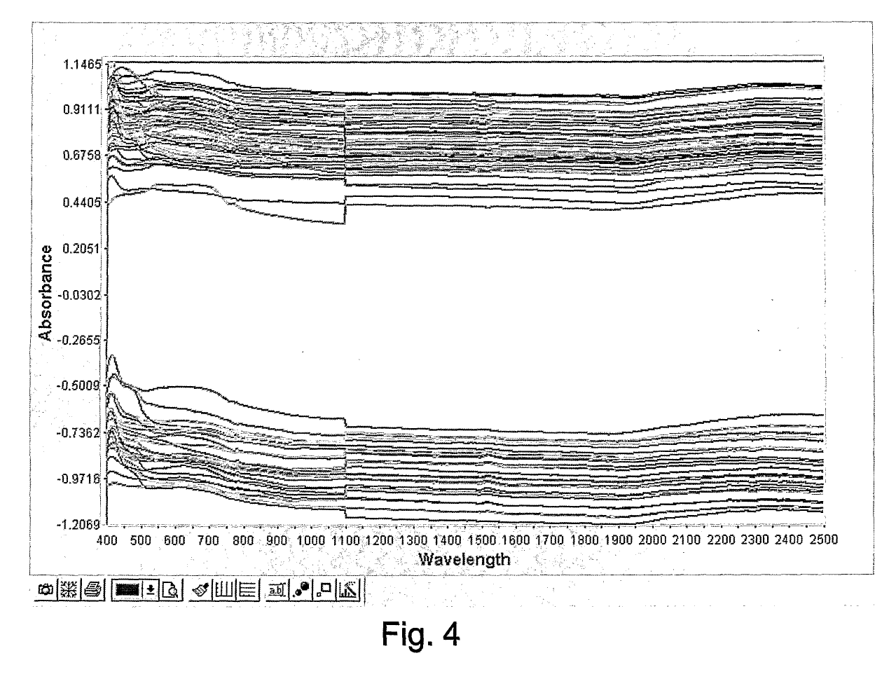

In FIG. 4 are depicted acquired absorption (transreflection) spectra from 400 to 2500 nm of 100 rough diamonds showing the lack of distinguishing features in the spectra.

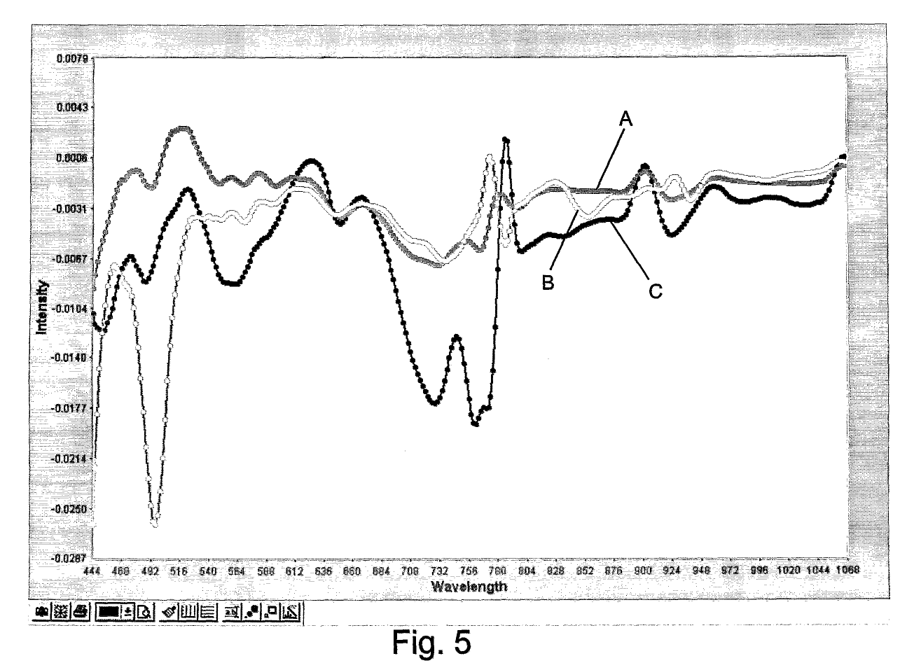

In contrast, in FIG. 5 are depicted processed reference spectra (absorbance (transreflectance) at 444 to 1068 nm) of three groups of diamonds: (A) non-fluorescent colorless rough diamonds (second derivative of the average spectra of 32 different diamonds, each spectrum acquired from nine different directions); (B) non-fluorescent fancy-yellow rough diamonds (second derivative of the average spectra of 18 different diamonds, each spectrum acquired from nine different directions); and (C) HTHP enhanced diamonds (second derivative of the average spectra of 10 different diamonds, each spectrum acquired from nine different directions).

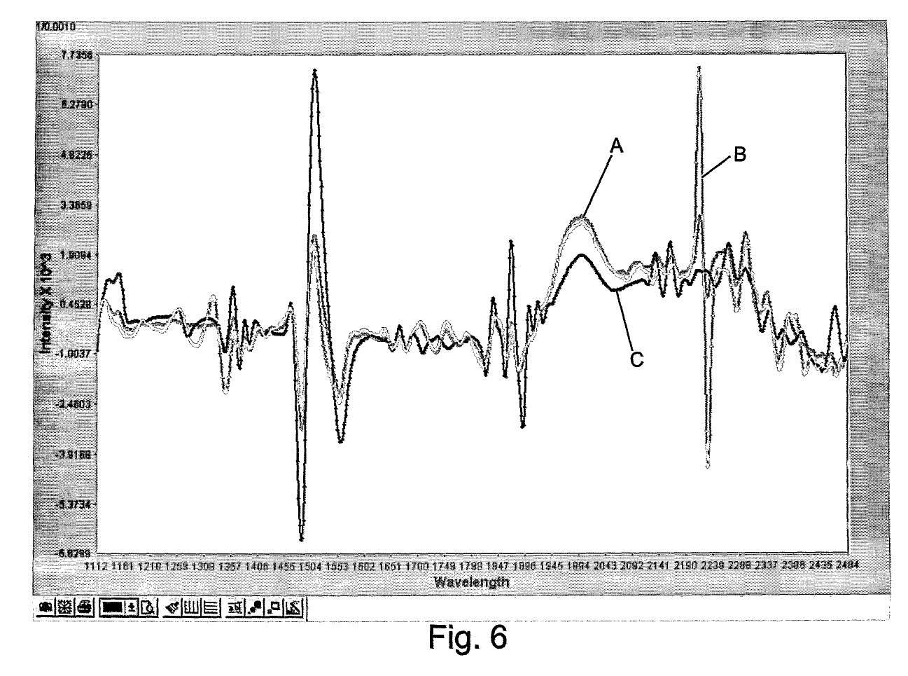

In FIG. 6 are depicted processed reference spectra (absorbance (transreflectance) at 1112 to 2484 nm) of three groups of diamonds: (A) non-fluorescent colorless rough diamonds (second derivative of the average spectra of 32 different diamonds, each spectrum acquired from nine different directions); (B) non-fluorescent fancy-yellow rough diamonds (second derivative of the average spectra of 18 different diamonds, each spectrum acquired from nine different directions); and (C) HTHP enhanced diamonds (second derivative of the average spectra of 10 different diamonds, each spectrum acquired from nine different directions).

As seen from FIGS. 5 and 6, the processed spectra which are the second derivatives of acquired absorbance spectra between 420-2480 nm are entirely different, each processed spectrum characteristic of its respective group, and can therefore be used as a reference spectrum. Further it is seen that each processed spectrum includes relatively small ranges of wavelengths that are themselves characteristic of diamonds of that group, for example 444-540 nm, 540-804 nm, 1602-1945 nm or 2190-2484 nm.

It is important to note that it is not necessarily possible to transfer reference spectra from one device to the other and rather, in embodiments a set of reference spectra are recalculated for a given device under given operating conditions.

In embodiments, the reference spectrum is a single spectrum, e.g., a spectrum derived from a single diamond or from the average of a number of spectra of different diamonds of the same group. In embodiments the reference spectra are a library of reference spectra.

### Relationship of Spectroscopic Data of Diamonds of a Group to Color Quality

According to aspects of the present invention, a relationship between spectroscopic data and the color quality of a diamond is sought. Once such a relationship is known, a diamond of unknown color quality is spectroscopically examined to extract the required data, and the data used to assess the color quality of the diamond. For example, in embodiments, the relationship is a mathematical equation where color quality is a function of at least two values of the second derivative of the absorption spectrum of a diamond. Thus, in embodiments it is necessary to determine a relationship between the absorbance of a diamond at a limited number of wavelengths (preferably at least two) and a value related to the color quality of the diamond. In embodiments, the relationship is between the absorbance of a rough diamond and the color grade of finished diamonds cut from the rough diamond.

The method for determining a relationship between spectroscopic data and the quality of color of a diamond is familiar to one skilled in the art upon perusal of the description herein.

The color quality of a plurality of diamonds belonging to a group is determined using standard methods (e.g., manual evaluation by a skilled craftsman). The color quality is then assigned a numerical value. For example, for implementing the teachings of the present invention, the standard diamond color grades known to one skilled in the art are assigned numerical values, see Tables 1 and 2, where the twenty groups of color grades are divided into 96 sub-groups.

For a given device to be used in implementing the teachings of the present invention, a spectrum of each of the plurality of diamonds of the group is acquired. Although in embodiments it is possible to acquire a spectrum from light interacting with the diamond through a single light path, it is preferred that the acquired spectrum be derived from (e.g., is a sum or average) of spectra including light interacting with the diamond through a plurality of light paths. Then the relationship between the variability between the acquired spectra and the variability of the color quality is determined. If necessary, the spectra are mathematically manipulated to yield a processed spectrum for each diamond.

In a preferred embodiment, the desired relationship is determined with the help of chemometric techniques with which one skilled in the art is acquainted. The assumption is made that at least some of the physical constituents that are responsible for the color quality of diamonds of a given group are linear with the spectral values at one or more wavelengths. Thus in embodiments, using a multivariate analysis method (e.g., multiple linear regression, partial least squares) standard chemometrics methods are used to select the spectral values at wavelengths having the highest correlation to the color quality. In principle it is possible to find relationships where any number of values correlates with the color quality of a diamond. That said, it has been found that the absorbance at three wavelengths is a conveniently small number that provides excellent correlation with the color quality of a diamond.

As presented in the experimental section below, absorbance spectra (420-2480 nm) of a group of 25 fluorescent colorless and fluorescent fancy-yellow rough diamonds were acquired. The second derivatives of the spectra were correlated to the numeric color grade of the diamonds of Table 2 (determined in the usual way after the rough diamonds were finished) using multiple linear regression. Found was that the color grade of a fluorescent colorless or fluorescent fancy-yellow rough diamond could be predicted using linear Formula I:

PCP=84.6+2110*(A₄₅₅)+17700*(A₇₄₀)+16800*(A₃₁₀)

where PCP is the predicted color of finished diamond with reference to Table 2; and A_{X} is the second derivative of the absorbance spectrum at X nm.

For validation, spectra of 14 fluorescent colorless and fluorescent fancy-yellow rough diamonds were acquired under conditions substantially identical to the conditions used for acquiring the spectra used in determining Formula I, the second derivative of the spectra calculated so as to provide the values of A₄₅₅, A₇₄₀ and A₁₃₁₀, and then Formula I used to provide a PCP for each of the 14 diamonds. The 14 diamonds were finished and the color determined in the usual way (manually, by skilled craftsmen under standard conditions). The colors determined by the craftsmen and the color qualities as assessed by Formula I were compared and it was found that Formula I has a standard error of prediction (SEP) of 2.7 and an RSQ of 0.973.

As presented in the experimental section below, absorbance spectra (420-2480 nm) of a group of 32 non-fluorescent colorless rough diamonds were acquired. The second derivatives of the spectra were correlated to the numeric color grade of the diamonds of Table 2 (determined in the usual way after the rough diamonds were finished) using partial least squares. Found was that the color grade of a non-fluorescent colorless rough diamond could be predicted using Formula I above.

Formula I was validated for 24 non-fluorescent colorless rough diamonds substantially as described above for fluorescent rough diamonds and found to have a standard error of prediction (SEP) of 1.5 and an RSQ of 0.967.

As presented in the experimental section below, absorbance spectra (420-2480 nm) of a group of 18 non-fluorescent fancy-yellow rough diamonds were acquired. The second derivatives of the spectra were correlated to the numeric color grade of the diamonds of Table 2 (determined in the usual way after the rough diamonds were finished) using multiple linear regression. Found was that the color grade of a non-fluorescent fancy-yellow rough diamond could be predicted using Formula II:

PCP=−17.0+17.4*(A₁₃₁₀/A₂₂₈₆)−5220*(A₂₁₁₀)

where PCP is the predicted color of finished diamond with reference to Table 2; and A_{X} is the second derivative of the absorbance spectrum at X nm.

Formula II was validated for 7 non-fluorescent fancy-yellow rough diamonds substantially as described above for fluorescent rough diamonds and found to have a standard error of prediction (SEP) of 3.0 and an RSQ of 0.911.

It is important to note, that it is not necessarily possible to use a relationship between color quality and spectral characteristics determined on one device on a different device.

The teachings of the present invention are advantageously used for assessing the color quality of a diamond for which the color quality is not known or for confirming the color quality of a diamond for which the color quality was assessed using a different method. For example, in embodiments the teachings of the present invention are used for assessing the color quality of a finished diamond by analyzing the spectral properties of the rough diamond from which the finished diamond is cut.

### Classification of a Diamond

In a first step, a diamond to be assessed is classified as belonging to one of the groups for which reference spectra are available. A spectrum of the diamond is acquired, processed, and compared (in the usual way with which one skilled in the art is familiar) to an available reference spectrum or spectra. If the processed spectrum correlates with the reference spectrum or spectra to a sufficient degree, the diamond is classified as belonging to the respective group.

Although in embodiments it is possible to acquire a spectrum from light interacting with the diamond through a single light path, it is preferred that the acquired spectrum be an average of spectra including light interacting with the diamond through a plurality of light paths.

In embodiments, classification of a diamond as belonging to a group is not performed by comparing to a reference spectrum, but rather according to a different physical property. For example, as presented in the experimental section, a first classification did not necessitate using a reference spectrum or spectra, but rather a diamond was classified according to the degree of fluorescence exhibited.

A rough diamond to be classified was irradiated with 366 nm light and the fluorescence evaluated as known to one skilled in the art. A rough diamonds having no or slight fluorescence were classified as belonging to the group of “non-fluorescent diamonds” while a rough diamond having faint, medium, strong, or very strong fluorescence were classified as belonging to the group of “fluorescent diamonds”.

If a diamond was classified as belonging to the group of “non-fluorescent diamonds”, an absorbance spectrum (420-2480 nm) of the diamond was acquired and a processed spectrum provided by taking the second derivative of the acquired spectrum.

The processed spectrum was compared to a library of 32 second derivatives of spectra of non-fluorescent colorless diamonds. Diamonds for which the processed spectrum had a correlation of greater than 0.9 were classified as belonging to the group of “non-fluorescent colorless diamonds”. In contrast, the correlation of processed spectra of non-fluorescent fancy-yellow diamonds gave significantly worse correlation coefficients, generally around 0.75.

The processed spectrum was compared to a library of 18 second derivatives of spectra of non-fluorescent fancy yellow diamonds. Diamonds for which the processed spectrum had a correlation of greater than 0.9 were classified as belonging to the group of “non-fluorescent fancy yellow diamonds”. In contrast, the correlation of processed spectra of non-fluorescent colorless diamonds gave significantly worse correlation coefficients, generally around 0.75.

Generally, once a diamond is classified as belonging to a given group, the classification is reported. As is clear to one skilled in the art upon perusal of the description herein, the group to which a diamond belongs may be reported in a number of ways, for example as a number, as a color or as a graphic representation.

### Assessment of the Color Grade of a Classified Diamond

As noted above, in embodiments once a diamond is classified as belonging to a group, it is often possible to assess the color quality of the diamond in accordance with the teachings of the present invention. Generally, a spectrum of the diamond is acquired, the spectrum is mathematically manipulated to provide a processed spectrum (e.g., a second derivative of the spectrum), the required values acquired from the processed spectrum, and using a relationship as determined above (e.g., Formula I or Formula II), the quality of the color of the diamond is assessed and usually reported. As is clear to one skilled in the art upon perusal of the description herein, the color grade may be reported in a number of ways, for example as a number, as a color or as a graphic representation

Although in embodiments it is possible to acquire the spectrum at the appropriate wavelengths through a single light path, it is preferred that the acquired spectrum be derived from a plurality of light paths (e.g., is an average or sum of a number of individual spectra acquired from different directions).

Once the color quality is assessed and reported, various decisions relating to the diamond may be made more accurately.

In embodiments, the color quality of a rough diamond is assessed. As is clear to one skilled in the art, the fact that the teachings of the present invention allow the assessment of the color quality of a finished diamond by investigation of a rough diamond from which the finished diamond is cut is of great utility. For example, decisions such as how to cut a rough diamond may be made rationally.

In embodiments, the method of the present invention is implemented, substantially as described above, to assess the color quality of a finished diamond or a processed diamond. It must be remembered that in the art it is known to assess the color of finished diamonds with the help of multiple skilled craftsmen under standardized viewing conditions. The teachings of the present invention allow an accurate assessment of the quality of the color of a diamond with the use of instrumentation.

### Determination if a Diamond is Enhanced/Synthetic

As noted above, enhanced and synthetic diamonds are generally marked as such by the manufacturers, but unscrupulous persons are known to erase the markings in order to present the diamonds as natural. Embodiments of the present invention allow determination if a diamond is enhanced or synthetic.

The method is performed substantially as described above. A spectrum of a suspect diamond is acquired and processed as described above to provide a processed spectrum. The processed spectrum is compared to a reference spectrum or spectra of enhanced and synthetic diamonds. If the processed spectrum correlates with the reference spectrum or spectra to a sufficient degree, the suspect diamond is determined to be an enhanced or synthetic diamond.

Under the experimental conditions as discussed below, the correlation of the second derivative of an absorbance spectrum (420-2480 nm) of an HPHT enhanced diamond to a reference library consisting of 10 equivalent spectra of 10 different HPHT enhanced diamonds gave a correlation coefficient of greater than 0.9. In contrast, the correlation of equivalent spectra of non-HPHT enhanced diamonds gave significantly worse correlation coefficients, generally around 0.5.

The teachings of the present invention are implementable using devices of the present invention.

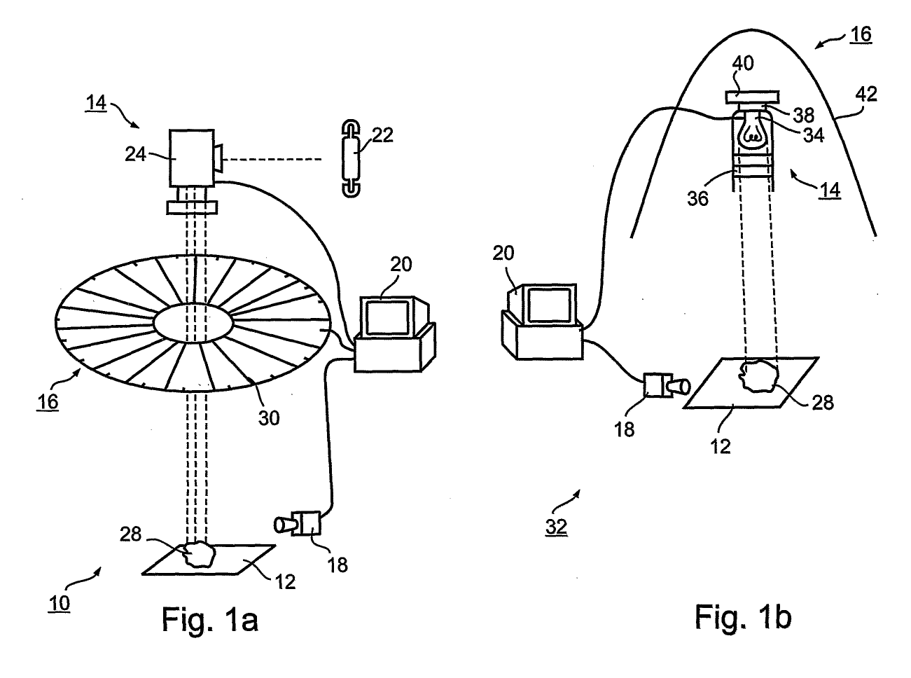

In FIG. 1A is depicted an embodiment of a device of the present invention 10, useful in implementing the teachings of the present invention. Device 10 includes a specularly reflective gemstone holder 12, an illumination unit 14, a detection unit 16, a fluorescence detector 18 and a control unit 20 that is configured to function as a spectrum-processing unit.

Illumination unit 14 of device 10 includes a light source 22, substantially a silicon carbide globar (Kanthal Globar Elektrowarme GmbH, Erlangen, Germany) producing a continuous spectrum of near-infrared and infrared radiation (wavelengths of between 1500 nm and 4000 nm) with an adjustable monochromator 24. Illumination unit 14 is configured to project light of a selected range of wavelengths at a rough diamond 28 held on reflective gemstone holder 12 substantially from one direction.

Detection unit 16 of device 10 includes a plurality of individual InGaAs detectors 30 (Xenics Ltd., Leuven, Belgium) as light sensitive components arranged as a circumferential detector array. Detection unit 16 is configured to measure the intensity of radiation that interacts with rough diamond 28 whether before or after reflection from reflective gemstone holder 12.

Control unit 20 is substantially a digital computer configured, using a combination of software, firmware and hardware, to control the other components of device 10 and to analyze acquired data.

For use, a rough diamond 28 is placed on reflective gemstone holder 12 and light source 22 activated. Under control of control unit 20, monochromator 24 is used in the usual way to irradiate diamond 28 with a selected small range of wavelengths of incoherent light at any one time (in embodiments of the present invention, each range of no more than about 50 nm, no more than about 30 nm, no more than about 20 nm, no more than about 10 nm, no more than about 5 nm and even no more than about 2 nm). The light passes through diamond 28 a first time, reflects from reflective gemstone holder 12 and passes through rough diamond 28 a second time. Some of the radiation that interacts with diamond 28 whether by reflection (both specular and diffusive), refraction, or scattering, at the surface or when passing through either the first time or the second time deviates from the optical axis of illumination unit 14, the intensity of which is measured by detectors 30 of detection unit 16. Simultaneously, fluorescence detector 18 is used to measure the intensity of radiation produced by fluorescent processes in diamond 28.

For each range of wavelengths produced by monochromator 24 to irradiate diamond 28 at any one time, control unit 20 registers the total intensity of light measured by detection unit 16 and the intensity of light measured by fluorescence detector 18

The number of steps, that is the number of wavelength ranges for which intensity of radiation is measured, is determined to cover a required portion of the spectrum to produce sufficiently accurate results as is discussed hereinbelow. It is important to note that the wavelength ranges of any two steps are generally, for convenience, contiguous, that is to say the spectrum is scanned. In such a way the rough diamond is irradiated with a continuous spectrum of light, generally but not necessarily where there is some degree of overlap of wavelength ranges. That said, embodiments of the present invention include noncontiguous wavelength ranges.

As is clear to one skilled in the art, the results of the series of measurements of a given diamond 28 constitute two spectra, a first spectrum with a wavelength abscissa and a radiation intensity ordinate measured by detection unit 14 and a second spectrum with a wavelength range abscissa and a fluorescence intensity ordinate measured by fluorescence detector 18. The spectra are stored in control unit 20 in any format, generally on electronic media,

In FIG. 1B is depicted an embodiment of a device of the present invention 32. Device 32 includes a diffusively reflective gemstone holder 12, an illumination unit 14, a detection unit 16, a fluorescence detector 18 and a control unit 20.

Illumination unit 14 of device 32 includes a light source 34, substantially a Xenon lamp (Hamamatsu Incorporated, Hamamatsu City, Japan) producing a continuous spectrum of ultraviolet through visible to infrared light (wavelengths of between 190 nm and 2000 nm) with a collimator 36. Illumination unit 14 is configured to project collimated radiation of a selected range of wavelengths at a rough diamond 28 held on reflective gemstone holder 12 substantially from one direction.

Detection unit 16 of device 10 includes photomultiplier tube 38 (Hamamatsu Incorporated, Hamamatsu City, Japan) as a light sensitive component and is configured to measure the intensity of radiation with frequencies of between about 115 nm and about 1700 nm functionally associated with a monochromator 40 positioned substantially at the focal point of parabolic reflector 42. Detection unit 16 is configured to measure the intensity of radiation that interacts with rough diamond 28 whether before or after reflection from gemstone holder 12.

Control unit 20 is substantially a computer configured, using a combination of software, firmware and hardware, to control the other components of device 10 and to analyze acquired data.

For use, a rough diamond 28 is placed on reflective gemstone holder 12 and light source 34 activated, irradiating diamond 28 with a collimated beam including the entire spectrum of radiation produced by light source 34. The radiation passes through diamond 28 a first time, reflects from reflective gemstone holder 12 and passes through rough diamond 28 a second time. Some of the radiation that interacts with diamond 28 whether by reflection (both specular and diffusive), refraction, or scattering, at the surface or when passing through either the first time or the second time deviates from the optical axis of illumination unit 14 to be directed by parabolic reflector 42 to be measured by photomultiplier tube 38 through monochromator 24. Under control of control unit 20, monochromator 40 is used to allow photomultiplier tube 38 to measure the intensity of a selected small range of wavelengths of incoherent radiations discussed above. Simultaneously, fluorescence detector 18 is used to measure the intensity of radiation produced by fluorescent processes in diamond 28.

For each range of wavelengths measured by photomultiplier tube 38 through monochromator 24 at any one time, control unit 20 registers the total intensity of radiation measured by detection unit 16 and the intensity of radiation detected by fluorescence detector 18.

As noted above, the number of steps, that is the number of wavelength ranges for which intensity of radiation is measured is determined to cover a required portion of the spectrum to produce sufficiently accurate results.

Device 32 is similar to device 10 depicted in FIG. 1A in that both devices are provided with a reflective gemstone holder 12, both are provided with an illumination unit 14 that produces an incoherent continuous spectrum of radiation, both measure the intensity of radiation that is reflected (specular as well as diffusive) by a diamond 28, that is transreflected through a diamond 28, that is scattered by a diamond 28 that is refracted through a diamond 28. In both devices illumination of a diamond 28 is from substantially a single direction at one time, but measurement of intensity is from a plurality (substantially infinite) of angles so that the measured radiation follows a plurality of substantially different paths through different sides of diamond 28. In both device 10 and device 32 the diameter of the light interacting is such that rough diamond 28 is irradiated substantially entirely when illumination unit is activated.

Device 32 is different from device 10, for example in that illumination unit 14 of device 32 produces collimated radiation. Further, whereas in device 10 monochromator 24 is a component of illumination unit 16 allowing pre-dispersal monochromation, in device 32 monochromator 40 is a component of detection unit 14 allowing post-dispersal monochromation.

In non-depicted embodiments that resemble devices 10 and 32, an illumination unit 14 is provided with a beam-producing unit, for example a beam-shaper, preferably an adjustable beam shaper that allows adjustment of the diameter of a beam of light produced by illumination unit 14 and directed at rough diamond 28.

In non-depicted embodiments that resemble devices 10 and 32, an illumination unit 14 is provided with a focusing unit, for example a lens or series of lenses, preferably with an adjustable focal point that allows adjustment of the focal point and thus the size of the light projected by illumination unit 14 and directed at rough diamond 28. Preferably, the focal point is adjusted to be inside a rough diamond 28 or just on the outer surface of a rough diamond 28.

Such a beam-producing unit or focusing unit allows light interacting with to be on the order of magnitude of size of a rough diamond 28 (e.g., at least 50%, at least 80%) as depicted for device 10 and device 32, or such a beam can be adjusted to be significantly smaller than the size of a rough diamond 28, (e.g., no more than 50%, no more than 30%, no more than 15%, no more than 5% and even no more than 1%).

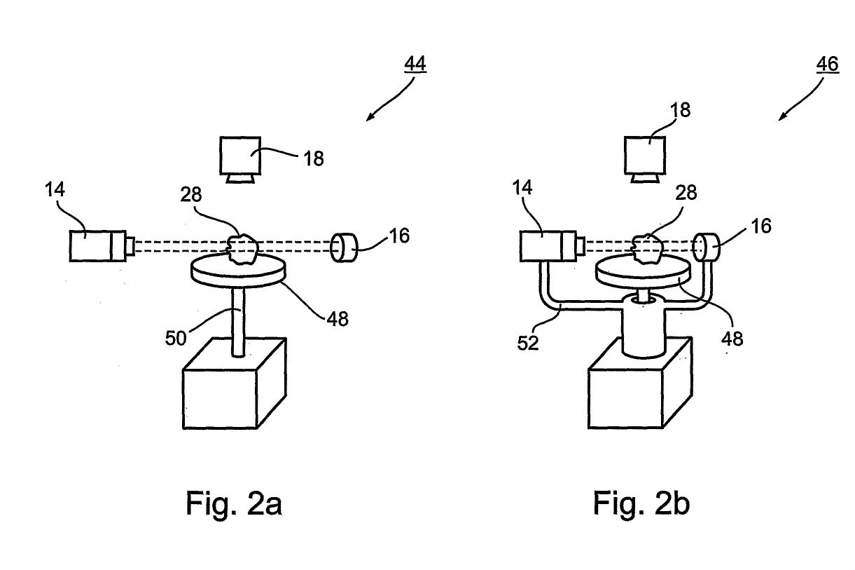

In FIG. 2A and in FIG. 2B are depicted embodiments of a device of the present invention 44 and 46 respectively. Both device 44 and device 46 include a gemstone holder 48, an illumination unit 14, a detection unit 16, a fluorescence detector 18 and a control unit (not depicted).

Illumination units 14 of both device 44 and device 46 substantially comprises a tunable laser (Opolette 532 Opotek Inc. Carlsbad, Calif. USA) as a light source producing coherent monochromatic light with wavelengths of from about 680 nm to about 2400 nm.

Detection units 16 of both device 44 and device 46 include an InGaAs detector (Xenics Ltd, Leuven, Belgium) light sensitive component. Detection units 16 are configured to measure the intensity of radiation that interacts with rough diamond 28 after passing through and interacting with a rough diamond 28 held on gemstone holder 48.

The respective control units of device 44 and 46 are substantially similar to control unit 20 of device 10 depicted in FIG. 1A.

In device 44 depicted in FIG. 2A gemstone holder 48 is a rotating gemstone holder rotatable about axis 50 (rotatable using a motor controlled by the respective control unit), while illumination unit 14 and detection unit 16 are fixed in place. In contrast, in device 46 depicted in FIG. 2B gemstone holder 48 is a static gemstone holder, while illumination unit 14 and detection unit 16 are affixed to rotatable mount 52 (rotatable using a motor controlled by the respective control unit).

For use, a rough diamond 28 is placed on a gemstone holder 48 and the laser comprising the light source of illumination unit 14 activated, irradiating rough diamond 28 with a monochromatic coherent beam of radiation. The radiation passes through diamond 28 interacting therewith. The intensity of radiation that passes through diamond 28 with substantially little deviation from the optical axis of illumination unit 14 is measured by detection unit 16. Under control of a respective control unit, radiation produced by a respective tunable laser constituting the light source of an illumination unit 24 is used to irradiate diamond 28 with different wavelengths of radiation. Simultaneously, fluorescence detector 18 is used to measure the intensity of radiation produced by fluorescent processes in diamond 28.

In device 44 depicted in FIG. 2A, for each given wavelength of radiation, rotating gemstone holder 48 is rotated about axis 50 under control of a respective control unit to irradiate diamond 28 and to measure the intensity of radiation passing therethrough through a plurality of different sides of diamond 28.

In contrast, in device 46 depicted in FIG. 2B, for each given wavelength of radiation, illumination unit 14 and detection unit 16 are rotated under control of a respective control unit to irradiate diamond 28 and to measure the intensity of radiation passing therethrough through a plurality of different sides of diamond 28.

In an embodiment, the wavelengths of light produced by illumination unit 14 are varied substantially continuously. In embodiments, the wavelengths of light are varied incremently with steps of no more than 50, no more than 30, no more than 20 and even no more than 10 nm per step.

For each wavelength produced by illumination source 14, control unit 20 registers the total intensity of radiation measured by detection unit 16 and the intensity of radiation measured by fluorescence detector 18.

As noted above, the number of steps, that is the number of wavelengths for which intensity of radiation is measured is determined to cover a required portion of the spectrum to produce sufficiently accurate results. As noted above, the results of a series of measurements of a given diamond 28 are most conveniently considered as constituting two spectra, a first spectrum with a wavelength range abscissa and a radiation intensity ordinate measured by detection unit 14 and a second spectrum with a wavelength range abscissa and a fluorescence intensity ordinate measured by fluorescence detector 18.

Devices 44 and 46 are different from both device 10 depicted in FIG. 1A and device 32 depicted in FIG. 1B in that an illumination unit 14 produces coherent and monochromatic light as opposed to incoherent polychromatic radiation. Further, whereas detection units 16 of device 10 and device 32 measure the intensity of radiation that substantially deviates from the optical axis of a respective illumination unit 14, detection units 16 of device 44 and device 46 measure the intensity of radiation that does not substantially deviate from the optical axis of a respective illumination unit 14. Further, whereas in device 10 and device 32 irradiation of a diamond 28 is from substantially a single direction at one time and measurement of intensity is from a plurality (substantially infinite) of angles simultaneously, in device 44 and device 46, irradiation of a diamond and measurement of the intensity of radiation subsequent to interaction therewith is from substantially a single direction at one time.

Devices 44 and 46 are substantially similar, a difference being that in device 44 gemstone holder 28 is configured to rotate relative to illumination unit 14 and detection unit 16 while in device 46 illumination unit 14 and detection unit 16 are configured to rotate about a gemstone such as diamond 28 held in gemstone holder 28. That said, in device 44 and device 46, the rotation of a respective gemstone holder 28 relative to a respective illumination unit 14 and a respective detection unit 16 leads to the measured radiation following a plurality of substantially different paths through different sides of diamond 28.

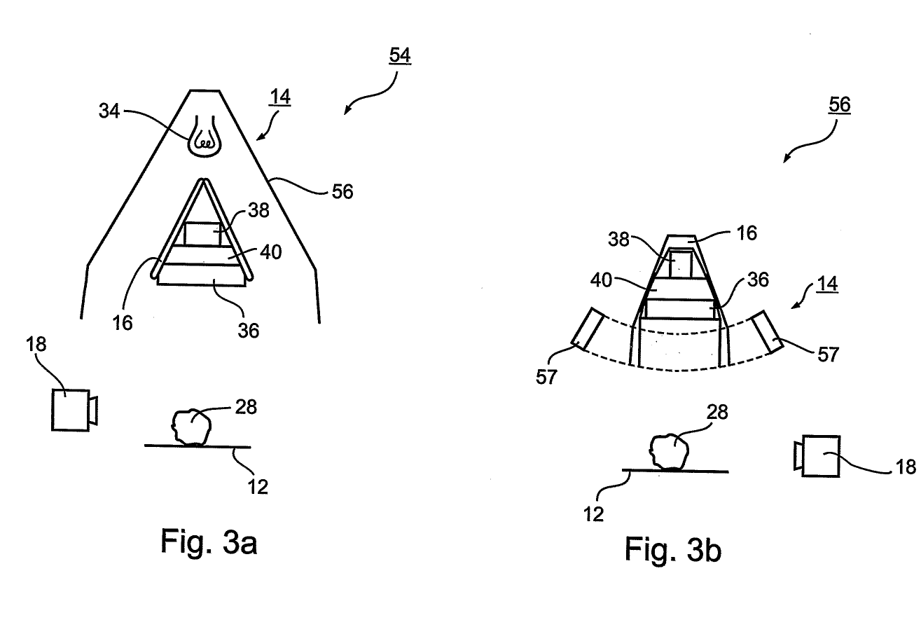

In FIG. 3A and in FIG. 3B are depicted embodiments of a device of the present invention 54 and 56 respectively. Both device 54 and device 56 include a reflective gemstone holder 12, an illumination unit 14, a detection unit 16, a fluorescence detector 18 and a control unit (not depicted).

Illumination unit 14 of device 54 depicted in FIG. 3A substantially comprises a Xenon lamp 34 (Hamamatsu Incorporated, Hamamatsu City, Japan) producing ultraviolet through visible to infrared (wavelengths of between 190 nm and 2000 nm) provided with a reflector 56 to direct radiation produced by Xenon lamp 34 at a rough diamond 28 on reflective gemstone holder 12.

Illumination unit 14 of device 56 depicted in FIG. 3B substantially comprises a plurality of deuterium lamps 57 (Hamamatsu Incorporated, Hamamatsu City, Japan) as light sources producing ultraviolet through visible (wavelengths of between 180 nm and 370 nm) arrayed in a circle so as, when activated, to illuminate a diamond 28 held on reflective gemstone holder 12.

Detection units 16 of both device 54 and device 56 include a collimator 36, an adjustable monochromator 40 and a detector 38 including a silicon photodiode (Electro-Optical Systems Inc, Phoenixville, Pa., USA) as a light sensitive component. Detection unit 16 is configured to measure the intensity of radiation that interacts with rough diamond 28 whether before or after reflection from reflective gemstone holder 12.

The respective control units of devices 54 and 56 are substantially similar to control unit 20 of device 10 depicted in FIG. 1A.

For use, a rough diamond 28 is placed on reflective gemstone holder 12 and light source 34 or light sources 57 activated, irradiating diamond 28 with radiation simultaneously from a plurality (substantially infinite) of directions including the entire spectrum of radiation produced by the respective light source 34 or light sources 57. The radiation passes through diamond 28 a first time, reflects from reflective gemstone holder 12 and passes through rough diamond 28 a second time. The intensity of some of the radiation that interacts with diamond 28 whether by reflection (both specular and diffusive), refraction, or scattering, at the surface or when passing through diamond 28 either the first time or the second time is measured by detector 38 after passing through collimator 36 and monochromator 40. Under control of a respective control unit, monochromator 40 is used to allow detector 38 to measure the intensity of a selected small range of wavelengths of incoherent radiation. Simultaneously, fluorescence detector 18 is used to measure the intensity of radiation produced by fluorescent processes in diamond 28.

For each range of wavelengths the intensity of which is measured by detector 38 through monochromator 40 at any one time, the respective control unit registers the total intensity of radiation measured by detection unit 16 and the intensity of radiation measured by fluorescence detector 18.

As noted above, the number of steps, that is the number of wavelength ranges for which intensity of radiation is measured is determined to cover a required portion of the spectrum to produce sufficiently accurate results. As noted above, the results of a series of measurements of a given diamond 28 are most conveniently considered as constituting two spectra, a first spectrum with a wavelength range abscissa and a radiation intensity ordinate measured by detection unit 14 and a second spectrum with a wavelength range abscissa and a fluorescence intensity ordinate measured by fluorescence detector 18.

Device 54 and 56 are substantially similar, a significant difference that illumination unit 14 of device 54 comprises one light source 34 whereas illumination unit 14 of device 56 comprises a plurality of light sources 57.

As noted above, whereas in device 10 and device 32 irradiation of a diamond 28 is from substantially a single direction at one time and measuring of intensity is from a plurality (substantially infinite) of angles simultaneously, in devices 54 and 56 measuring of intensity of radiation is substantially from a single direction while irradiation is from a plurality of (substantially infinite) angles simultaneously, leading to measured radiation following a plurality of substantially different paths through different sides of diamond 28.

Generally, an illumination unit is configured to produce any useful wavelength range of radiation, including ultraviolet (between about 3 and about 400 nm), visible (between about 400 and 700 nm) and infrared (between about 700 and 3×10⁶ nm). That said, as seen in the experimental results below most useful are visible wavelengths (between about 400 and 700 and near-infrared wavelengths (between about 700 and about 2500 nm) provide the best results.

Generally, any suitable light source is appropriate for implementing the teachings of the present invention include coherent and non-coherent light sources, such as a globar, a tunable laser, a halogen lamp or a Xenon lamp. Other light sources suitable for implementing the teachings of the present invention include but are not limited to tungsten-halogen lamps (generally producing light with UV, visible and NIR frequencies between 350 nm and 2000 nm), ultraviolet lamps, high pressure mercury lamps, medium pressure mercury lamps, deuterium lamps (generally producing light with UV and visible frequencies between 140 nm and 300 nm), light-emitting diodes and nichrome light sources.

Generally, any suitable type of monochromator is appropriate for implementing the teachings of the present invention including, but not limited to, optical filters, discrete optical filters, wedge optical filters, tilting filter wheels, interference filters, prisms, diffraction gratings, holographic diffraction gratings, moving diffraction gratings, stigmatic diffraction gratings, Fourier-transform interferometers, Michelson Fourier-transform interferometers, Wishbone Fourier-transform interferometers, Fishbone Fourier-transform interferometers Crystal Fourier-transform interferometers, Acoustic Optical Tunable Filters and Optical Micro Electronic Mechanical Systems.

Generally, any suitable type of detection unit is appropriate for implementing the teachings of the present invention including, but not limited to, detection units having a component such as an optical sphere, a photomultiplier tube, a photomultiplier component, a pyroelectric component, a thermocouple, a thermistor or a photon detector. Suitable components optionally include crystals such as Si, BaS, PbS, PbSe, InAs, InSb, Si/PbS or InGaAs.

Embodiments of the method of the present invention are of assessing the color of a diamond include a step of acquiring a spectrum of radiation subsequent to interaction with the diamond, where each wavelength or range of wavelengths of the abscissa of the spectrum includes an intensity of radiation detected after following a plurality of substantially different light paths through different sides of the rough diamond. Such a spectrum is preferably acquired using an embodiment of a device of the present invention, substantially as described hereinabove. That said, it is within the ability of one of average skill in the art to acquire a suitable spectrum using any appropriate device upon perusal of the description herein.

In general, a spectrum of including any wavelengths of radiation is suitable for implementing the teachings of the present invention including ultraviolet (between about 3 and about 400 nm), visible (between about 400 and 700 nm) and infrared (between about 700 and 3×10⁶ nm), but especially near-infrared (between about 700 and about 2500 nm).

### Classification of a Diamond

In embodiments of the present invention, a diamond (rough, finished or being processed) is irradiated with a plurality of wavelengths of light from an illumination unit and a spectrum of the light subsequent to interaction with the diamond is acquired using a detection unit, using a suitable device, for example using an embodiment of a device of the present invention as described herein. Subsequently, the acquired spectrum is mathematically processed with a spectrum processing method to provide a processed spectrum. The processed spectrum is compared to at least one reference spectrum of a group of diamonds to determine if the diamond is a member of the group of diamonds.

In embodiments of the present invention, the spectrum processing method includes a mathematical manipulation of the acquired spectrum, for example one or more of smoothing, baseline correction, subtracting, multiplying, dividing, multiplicative scatter correction (MSC), detrending, derivatization, first order derivatization, second order derivatization, third order derivatization, fourth order derivatization, smoothing and Savitzky-Golay smoothing. Preferably, the mathematical manipulation comprises second order derivatization of the acquired spectrum to provide the processed spectrum.

In embodiments, the at least one reference spectrum comprises a spectrum of a diamond of the group. In embodiments, the at least one reference spectrum comprises a library of spectra of diamonds of the group. In embodiments, the at least one reference spectrum comprises an average of a plurality of spectra of diamonds of the group.

In embodiments, the comparing provides a correlation value indicative of the degree of similarity of the processed spectrum to the at least one reference spectrum and determining if the diamond is a member of the group of diamonds includes that the correlation value exceeds a predetermined threshold.

In embodiments, classification of a diamond is dependent, at least in part, on the fluorescence spectrum (wavelengths, intensity or both) of the diamond. In such embodiments, it is preferred to acquire a fluorescence spectrum of the diamond substantially simultaneously with acquisition of the light/diamond interaction spectrum, substantially as described above, to allow more efficient classification of the diamond.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXPERIMENTAL

Reference is now made to the following examples, which together with the above descriptions, illustrate the invention in a non limiting fashion.

A set of 120 rough diamonds from different sources and geographical locations and of various weights, colors and shapes were collected. Twenty HTHP enhanced diamonds of various sizes were also collected

### Spectroscopy

A commercially available VIS-NIR spectrophotometer Model 6500 (FOSS-NIRSystems™ Inc. Laurel, Md., USA) provided with a Direct Contact Analyzer Module from the same manufacturer was used to measure the absorbance in transreflectance mode of each of the set of rough diamonds. Chemometric calculations and mathematical manipulations were performed using the Vision™ software provided with the VIS-NIR spectrophotometer.

For each of the 140 diamonds, nine spectra from 400 to 2500 nm were acquired, where each spectrum was acquired when the diamond was placed on the quartz window in the sample compartment in a different orientation. For each of the diamonds, the nine acquired spectra were summed to yield a single representative spectrum.

### Fluorescence

Using the standard procedure known to one in the art of gemology, the fluorescence of each rough diamond was characterized. Each rough diamond was irradiated with a beam of ultraviolet light at 366 nm in a U.V. Colorscope System (System Eickhorst, Hamburg, Germany) and the fluorescence rated by a gemologist on the industry accepted scale of 1-6 (1 no fluorescence; 2 slight; 3 faint; 4 medium; 5 strong; and 6 very strong).

### Color Quality Grading of Finished Diamonds

The rough diamonds were further processed, cut and polished in the usual way so that each rough diamond yielded one or more finished diamonds. The color of the finished diamonds were graded in the usual way on the D to Z scale as well as the fancy yellow scale. Each grade was assigned a numerical value from 100.4 to 0.1, see Table 1 and Table 2.

TABLE 1
color groups and sub groups

| | | | Intensity of |
|---|---|---|---|
| Color grade | Sub group | Sub group strength | color grade |
| Colorless | D | 1, 2, 3, 4, 5 | 100.4 |
| | E | 1, 2, 3, 4, 5 | 98 |
| | F | 1, 2, 3, 4, 5 | 94 |
| Near colorless | G | 1, 2, 3, 4, 5 | 88 |
| | H | 1, 2, 3, 4, 5 | 77 |
| | I | 1, 2, 3, 4, 5 | 68 |
| | J | 1, 2, 3, 4, 5 | 61 |
| Faint yellow | K | 1, 2, 3, 4, 5 | 44 |
| | L | 1, 2, 3, 4, 5 | 40 |
| | M | 1, 2, 3, 4, 5 | 37 |
| Very light yellow | N-O-P | 1, 2, 3, 4, 5 | 35 |
| | Q-R-S | 1, 2, 3, 4, 5 | 33 |
| | T-U-V | 1, 2, 3, 4, 5 | 32 |
| Light yellow | W-X | 1, 2, 3, 4, 5 | 30 |
| | Y-Z | 1, 2, 3, 4, 5 | 28 |
| Fancy | F.L.Y. | 1, 2, 3, 4, 5 | 22 |
| | F.Y. | 1, 2, 3, 4, 5 | 15 |
| | F.I.Y. | 1, 2, 3, 4, 5 | 8 |
| | F.V.Y. | 1, 2, 3, 4, 5 | 4 |
| | F.D.Y. | 1, 2, 3, 4, 5 | 1 |

TABLE 2
Numerical value for GIA color grade

| Description | GIA Group and | Color Numeric values |
|---|---|---|
| colorless | D | 100.4 |
| colorless | E 5 | 99.6 |
| colorless | E 4 | 98.8 |
| colorless | E 3 | 98 |
| colorless | E 2 | 97.2 |
| colorless | E 1 | 96.4 |
| colorless | F 5 | 95.6 |
| colorless | F 4 | 94.8 |
| colorless | F 3 | 94 |
| colorless | F 2 | 92.8 |
| colorless | F 1 | 91.6 |
| near colorless | G 5 | 90.4 |
| near colorless | G 4 | 89.2 |
| near colorless | G 3 | 88 |
| near colorless | G 2 | 85.8 |
| near colorless | G 1 | 83.6 |
| near colorless | H 5 | 81.4 |
| near colorless | H 4 | 79.2 |
| near colorless | H 3 | 77 |
| near colorless | H 2 | 75.2 |
| near colorless | H 1 | 73.4 |
| near colorless | I 5 | 71.6 |
| near colorless | I 4 | 69.8 |
| near colorless | I 3 | 68 |
| near colorless | I 2 | 66.6 |
| near colorless | I 1 | 65.2 |
| near colorless | J 5 | 63.8 |
| near colorless | J 4 | 62.4 |
| near colorless | J 3 | 61 |
| near colorless | J 2 | 57.6 |
| near colorless | J 1 | 54.2 |
| faint yellow | K 5 | 50.8 |
| faint yellow | K 4 | 47.4 |
| faint yellow | K 3 | 44 |
| faint yellow | K 2 | 43.2 |
| faint yellow | K 1 | 42.4 |
| faint yellow | L 5 | 41.6 |
| faint yellow | L 4 | 40.8 |
| faint yellow | L 3 | 40 |
| faint yellow | L 2 | 39.4 |
| faint yellow | L 1 | 38.8 |
| faint yellow | M 5 | 38.2 |
| faint yellow | M 4 | 37.6 |
| faint yellow | M 3 | 37 |
| faint yellow | M 2 | 36.6 |
| faint yellow | M 1 | 36.2 |
| VLY | NOP 5 | 35.8 |
| VLY | NOP 4 | 35.4 |
| VLY | NOP 3 | 35 |
| VLY | NOP 2 | 34.6 |
| VLY | NOP 1 | 34.2 |
| VLY | QRS 5 | 33.8 |
| VLY | QRS 4 | 33.4 |
| VLY | QRS 3 | 33 |
| VLY | QRS 2 | 32.8 |
| VLY | QRS 1 | 32.6 |
| VLY | TUV 5 | 32.4 |
| VLY | TUV 4 | 32.2 |
| VLY | TUV 3 | 32 |
| VLY | TUV 2 | 31.6 |
| VLY | TUV 1 | 31.2 |
| LY | WX 5 | 30.8 |
| LY | WX 4 | 30.4 |
| LY | WX 3 | 30 |
| LY | WX 2 | 29.6 |
| LY | WX 1 | 29.2 |
| LY | YZ 5 | 28.8 |
| LY | YZ 4 | 28.4 |
| LY | YZ 3 | 28 |
| LY | YZ 2 | 26.8 |
| LY | YZ 1 | 25.6 |
| fancy | FLY 5 | 24.4 |
| fancy | FLY 4 | 23.2 |
| fancy | FLY 3 | 22 |
| fancy | FLY 2 | 20.6 |
| fancy | FLY 1 | 19.2 |
| fancy | FY 5 | 17.8 |
| fancy | FY 4 | 16.4 |
| fancy | FY 3 | 15 |
| fancy | FY 2 | 13.6 |
| fancy | FY 1 | 12.2 |
| fancy | FIY 5 | 10.8 |
| fancy | FIY 4 | 9.4 |
| fancy | FIY 3 | 8 |
| fancy | FIY 2 | 7.2 |
| fancy | FIY 1 | 6.4 |
| fancy | FVY 5 | 5.6 |
| fancy | FVY 4 | 4.8 |
| fancy | FVY 3 | 4 |
| fancy | FVY 2 | 3.4 |
| fancy | FVY 1 | 2.8 |
| fancy | FDY 5 | 2.2 |
| fancy | FDY 4 | 1.6 |
| fancy | FDY 3 | 1 |
| fancy | FDY 2 | 0.6 |
| fancy | FDY 1 | 0.1 |

### Reference Spectra for Each Group of Diamonds

Using VIS-NIR spectral identification methods, three different groups of diamonds were defined: HTHP enhanced diamonds, non-fluorescent colorless rough diamonds and non-fluorescent fancy yellow rough diamonds. It was decided that it was unnecessary to develop a VIS-NIR spectral identification method for fluorescent rough diamonds (rough diamonds having faint, medium, strong, or very strong fluorescence) as these are identifiable on the basis of fluorescence.

The spectral identification methods were developed to be applied to the second derivative of an acquired absorption spectrum. The second derivative of a spectra exhibits improved peak resolution. The spectral identification methods developed apply pattern recognition algorithms.

For each of the three groups of diamonds, a library of sample spectra of diamonds belonging to the group was created.

For each of the three groups, the correlation between the second derivative of absorption intensity as a function of wavelength of each sample spectrum was correlated to that of the other spectra making up the library of that group.

A correlation threshold value (greater than 0.9) was set to indicate a high degree of similarity between the spectra making up a library. Such a correlation method is sensitive to the “peaks and valleys” patterns of the spectra. Generally, such a correlation method is more sensitive to peak shifts than to changes in peak heights.

Once a correlation method was developed, it was possible to analyze an unknown diamond against a library of one of the groups, where the match value is calculated between the second derivative of the absorbance spectrum and that of the spectra making up the library. If the match value exceeds a certain threshold value, the unknown diamond is designated as being a member of the group of that library.

An HTHP enhanced diamond spectrum library was designated as the reference for the group of HTHP enhanced diamonds including the second derivatives of the spectra of ten HTHP enhanced diamonds (see, for example (C) in FIGS. 5 and 6). It was found that the second derivative of spectra of any one of the ten HTHP enhanced diamonds not included in the library had a correlation of at least 0.9 with the HTHP enhanced diamond library while the second derivative of spectra of non-HTHP enhanced diamonds had a much lower correlation, usually of around 0.5.

A non-fluorescent colorless diamond spectrum library was designated as the reference for the group of non-fluorescent colorless diamonds including the second derivatives of the spectra of 32 non-fluorescent colorless diamonds (see, for example (A) in FIGS. 5 and 6). It was found that the second derivative of spectra of any one of 24 non-fluorescent colorless diamonds not included in the library had a correlation of at least 0.9 with the non-fluorescent colorless diamond library while the second derivative of spectra of other diamonds had a much lower correlation, usually of around 0.75.

A non-fluorescent fancy yellow diamond spectrum library was designated as the reference for the group of non-fluorescent fancy yellow diamonds including the second derivatives of the spectra of 18 non-fluorescent fancy yellow diamonds (see, for example (B) in FIGS. 5 and 6). It was found that the second derivative of spectra of any one of 7 non-fluorescent fancy yellow diamonds not included in the library had a correlation of at least 0.9 with the non-fluorescent fancy yellow diamond library while the second derivative of spectra of other diamonds had a much lower correlation, usually of around 0.75.

### Relationship of Absorbance of Diamonds of a Group to Color Quality

The second derivatives of spectra of 25 fluorescent rough diamonds were correlated with the numerical value of the manually determined color grade (Table 2) of finished diamonds produced from the rough diamonds using the standard chemometric software in the usual way using multiple linear regression. Found was that the color grade of a fluorescent colorless and fluorescent fancy-yellow rough diamond could be predicted using Formula I:

PCP=84.6+2110*(A₄₅₅)+17700*(A₇₄₀)+16800*(A₃₁₀)

with a SEC of 3.1 and an RSQ of 0.975 where PCP is the predicted color of finished diamond with reference to Table 2; and A_{X} is the second derivative of the absorbance spectrum at X nm. Formula I was validated with spectra of 14 fluorescent colorless and fluorescent fancy-yellow rough diamonds and found to have a standard error of prediction (SEP) of 2.7 and an RSQ of 0.973.

The second derivatives of spectra of 32 non-fluorescent colorless rough diamonds were correlated with the numerical value of the manually determined color grade (Table 2) of finished diamonds produced from the rough diamonds using the standard chemometric software in the usual way using partial least squares. Found was that the color grade of a non-fluorescent colorless rough diamond could be predicted using Formula I with a SEC of 2.5 and an RSQ of 0.917 where PCP is the predicted color of finished diamond with reference to Table 2; and A_{X} is the second derivative of the absorbance spectrum at X nm. Formula I was validated with spectra of 24 non-fluorescent colorless rough diamonds and found to have a standard error of prediction (SEP) of 1.5 and an RSQ of 0.967.

The second derivatives of spectra of 18 non-fluorescent fancy yellow rough diamonds were correlated with the numerical value of the manually determined color grade (Table 2) of finished diamonds produced from the rough diamonds using the standard chemometric software in the usual way using multiple linear regression.

Found was that the color grade of a non-fluorescent fancy-yellow rough diamond could be predicted using Formula II:

PCP=−17.0+17.4*(A₁₃₁₀/A₂₂₈₆)−5220*(A₂₁₁₀)

with a SEC of 1.8 and an RSQ of 0.918 where PCP is the predicted color of finished diamond with reference to Table 2; and A_{X} is the second derivative of the absorbance spectrum at X nm. Formula II was validated with spectra of 7 non-fluorescent fancy-yellow rough diamonds and found to have a standard error of prediction (SEP) of 3.0 and an RSQ of 0.911.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-71. (canceled)

72. A method of assessing the color quality of a diamond, comprising:
a) acquiring a spectrum of a diamond, wherein said spectrum includes near infrared wavelengths;
b) using a mathematical manipulation method to mathematically process said acquired spectrum to provide a processed spectrum of said diamond;
c) acquiring spectral values from said processed spectrum at least two different wavelengths;
d) determining an algorithm relating the spectral values from said processed spectrum of said diamond at said at least two wavelengths to a value related to a quality of color of a diamond thereby to assess the color quality of said diamond.

73. The method of claim 72, wherein said diamond is a rough diamond.

74. The method of claim 72, wherein said diamond exhibits fluorescence.

75. The method of claim 72, wherein said acquired spectrum comprises near-infrared wavelengths between about 1100 nm and about 2500 nm.

76. The method of claim 72, wherein said acquired spectrum is obtained using a plurality of paths through different sides of said diamond.

77. The method of claim 72, wherein said mathematical manipulation method is at least one mathematical manipulation method selected from the group consisting of smoothing, baseline correction, subtracting, multiplying, dividing, multiplicative scatter correction (MSC), detrending, derivatization, first order derivatization, second order derivatization, third order derivatization, fourth order derivatization, and Savitzky-Golay smoothing.

78. The method of claim 72, wherein said mathematical manipulation method comprises second order derivatization of said acquired spectrum to provide said processed spectrum.

79. The method of claim 72, wherein the spectral values are acquired from said processed spectrum at least three different wavelengths.

80. A method of classifying a given diamond, comprising the following steps:
a) irradiating a diamond with electromagnetic radiation having a plurality of wavelengths including near infrared wavelengths;
b) acquiring a spectrum of said plurality of wavelengths subsequent to interaction with said diamond;
c) mathematically processing said acquired spectrum using a spectrum processing method to provide a processed spectrum; and
d) comparing said processed spectrum to at least one reference spectrum of a training set of spectra related to a predefined group of diamonds so as to determine if said given diamond is classifiable as a member of said predefined group of diamonds.

81. The method of claim 80, wherein said given diamond is a rough diamond.

82. The method of claim 80, wherein said group of diamonds comprises enhanced and synthetic diamonds.

83. The method of claim 80, wherein said given diamond exhibits fluorescence.

84. The method of claim 80, wherein said plurality of wavelengths comprises near-infrared wavelengths between the wavelengths of about 1100 nm and about 2500 nm.

85. The method of claim 80, wherein said interaction in said step of acquiring is through a plurality of paths through different sides of a rough diamond.

86. The method of claim 80, wherein said spectrum processing method includes mathematical manipulation of said acquired spectrum.

87. The method of claim 86, wherein said mathematical processing comprises at least one mathematical manipulation from the group consisting of smoothing, baseline correction, subtracting, multiplying, dividing, multiplicative scatter correction (MSC), detrending, derivatization, first order derivatization, second order derivatization, third order derivatization, fourth order derivatization, and Savitzky-Golay smoothing.

88. The method of claim 86, wherein said mathematical processing comprises second order derivatization of said acquired spectrum to provide said processed spectrum.

89. The method of claim 80, wherein said step of comparing includes correlating said processed spectrum to said at least one reference spectrum.

90. A device for assessing the color of diamonds comprising:
a. a gemstone holder;
b. an illumination unit to irradiate a diamond held in said holder with electromagnetic radiation; and
c. a detection unit to measure a spectrum produced by the irradiation from said illumination unit subsequent to interaction of the radiation with the diamond wherein each wavelength said spectrum has associated therewith spectral intensities obtained using a plurality of substantially different paths relative to the sides of the diamond.

91. The device of claim 90, further comprising a fluorescence detector to detect fluorescence from a diamond held in said gemstone holder.

92. The device of claim 90, further comprising a spectrum-processing unit configured to process an acquired spectrum and return a processed spectrum.

93. The device of claim 92, wherein the processing in said spectrum-processing unit includes at least one mathematical manipulation, selected from a group consisting of the following manipulations: smoothing, baseline correction, subtracting, multiplying, dividing, multiplicative scatter correction (MSC), detrending, derivatization, first order derivatization, second order derivatization, third order derivatization, fourth order derivatization, and Savitzky-Golay smoothing.

94. The device of claim 92, wherein the processing in said spectrum-processing unit includes a mathematical manipulation, wherein said mathematical manipulation comprises second order derivatization.

95. The device of claim 92, further comprising a spectrum-comparing unit configured to compare a processed spectrum of the irradiated diamond to at least one reference spectrum of a training set of spectra, the training set obtained from a group of diamonds so as to determine if the irradiated diamond has a color similar to that of the group of diamonds.

96. The method of claim 95, wherein said spectrum-comparing unit provides a correlation value indicative of the degree of similarity of the processed spectrum to the at least one reference spectrum and thereby determining if the diamond is a member of the group of diamonds when the correlation value exceeds a predetermined threshold value.
